(19) United States
(12) Patent Application Publication
(10) Pub. No.: US 2026/0288673 A1
(43) Pub. Date: Sep. 24, 2026

(54) CASCADED SERIAL CHAIN CONNECTION OF DEVICE DRIVER CIRCUITS

(71) Applicant: TEXAS INSTRUMENTS INCORPORATED, Dallas, TX (US)

(72) Inventors: Yanqin Cao, Shaanxi (CN); Chih Pu Yeh, Shanghai (CN); Feiyang Gong, Shanghai (CN); Sheng Guo, Shanghai (CN)

(21) Appl. No.: 19/086,603

(22) Filed: Mar. 21, 2025

(51) Int. Cl. G06F 13/42; G06F 13/40

(52) U.S. Cl. CPC G06F 13/4291; G06F 13/4072

(57) ABSTRACT

An apparatus comprises a plurality of device driver circuits, each configurable to drive one or more devices of a specific type, wherein the plurality of device driver circuits are serially connected in a chain connection, and wherein each of the plurality of device driver circuits includes a data input pin configurable to receive a data input signal, a clock input pin configurable to receive a clock input signal, a data output pin configurable to transmit a data output signal, a clock output pin configurable to transmit a clock output signal, and an inverter configurable to generate the clock output signal by inverting the clock input signal.

### BACKGROUND

Device driver circuits (or device drivers in short) are used to provide power (voltages and currents) to drive a wide variety of devices in various applications. For examples, LCD/LED device driver circuits are widely used to drive LCD/LED displays in TVs, monitors, notebooks, and automotive infotainment systems such as panoramic head-up displays (PHUD). In a display system such as a backlight board where hundreds or even thousands of LCDs/LEDs are implemented, the dimming zones on the backlight board are controlled independently by a main controller via a number of LCD/LED driver circuits to achieve higher resolutions compared to edge backlight. Due to the large number of the LCD/LED driver circuits being used, the communications between the main controller and the LED drivers are critical.

In many applications, a star-shaped communication topology is commonly used to support large amount of data transmission wherein there is a direct clock connection between the main controller and each of the device driver circuits following a master-slave communication protocol such as the Serial Peripheral Interface (SPI) protocol. Such star-shaped topology, however, suffers from complex layout design and serious electromagnetic interference (EMI) caused by high-frequency interface clocks, especially with a large number of device driver circuits. In addition, as the number of devices continues to increase, the interface timing design of the device driver circuits becomes increasingly complex and critical.

### SUMMARY

In an example, an apparatus comprises a plurality of device driver circuits, each configurable to drive one or more devices of a specific type, wherein the plurality of device driver circuits are serially connected in a chain connection, and wherein each of the plurality of device driver circuits includes a data input pin configurable to receive a data input signal, a clock input pin configurable to receive a clock input signal, a data output pin configurable to transmit a data output signal, a clock output pin configurable to transmit a clock output signal, and an inverter configurable to generate the clock output signal by inverting the clock input signal.

In another example, an apparatus comprises a plurality of device driver circuits, each configurable to drive one or more devices of a specific type, wherein the plurality of device driver circuits are serially connected in a chain connection, and wherein each of the plurality of device driver circuits includes a data input pin configurable to receive a data input signal, a clock input pin configurable to receive a clock input signal, a data output pin configurable to transmit a data output signal, a clock output pin configurable to transmit a clock output signal, and a circuitry configurable to determine a timeout period of the input clock signal and reset the each of the plurality of device driver circuits if the timeout period of its input clock signal exceeds a preset timeout threshold.

In another example, a method comprises receiving a data input signal at each of a plurality of device driver circuits each configurable to drive one or more devices of a specific type, wherein the plurality of device driver circuits are serially connected in a chain connection. The method further comprises receiving a clock input signal at the each of a plurality of device driver circuits, transmitting a data output signal at the each of a plurality of device driver circuits, and transmitting a clock output signal at the each of a plurality of device driver circuits, wherein the clock output signal is inverted from the clock input signal.

In another example, a method comprises receiving a data input signal at each of a plurality of device driver circuits each configurable to drive one or more devices of a specific type, wherein the plurality of device driver circuits are serially connected in a chain connection. The method further comprises receiving a clock input signal at the each of a plurality of device driver circuits, transmitting a data output signal at the each of a plurality of device driver circuits, transmitting a clock output signal at the each of a plurality of device driver circuits, determining a timeout period of the input clock signal, and resetting the each of the plurality of device driver circuits if the timeout period of its input clock signal exceeds a preset timeout threshold.

### BRIEF DESCRIPTION OF THE DRAWINGS

FIG. 1 is an illustrative example of a schematic diagram of a cascaded serial connection of device driver circuits, in an example.

FIG. 2 depicts an example of waveforms of the system clock output signal SCLK and the data output signal MOSI transmitted from the controller and the corresponding clock input signal CLKI and data input signal SIN_1 received at the first device driver circuit, in an example.

FIG. 3 depicts an example of a schematic diagram of circuitries inside each device driver circuit, wherein such circuitries are used to process the clock input signal CLKI received into the device driver circuit, in an example.

FIG. 4 depicts an example of levels of clock input signals CLKIs and data input signals SINs at the first device driver circuit, the second device driver circuit, and a third device driver circuit in the plurality of device driver circuits, in an example.

FIG. 5 depicts an example of waveforms of the clock output signal SCLK and data output signal MOSI from the controller as well as clock input signals CLKIs and data input signals SINs at the first device driver circuit and the second device driver circuit during a timeout, in an example.

### DETAILED DESCRIPTION

The same reference numbers or other reference designators are used in the drawings to designate the same or similar (either by function and/or structure) features.

Although Serial Peripheral Interface (SPI) protocol is used as a nonlimiting example of the data communication/transfer protocol between a controller and a plurality of device driver circuits in the discussions below, the same or similar approaches are also applicable to other types of data communication/transfer protocols as understood by one skilled in the art.

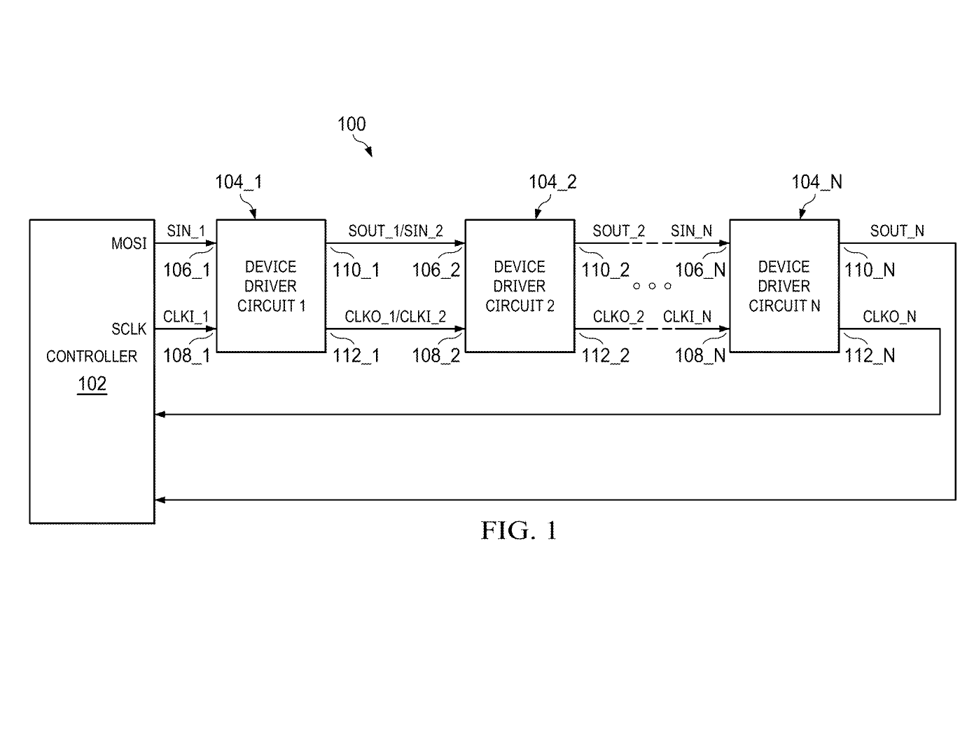

FIG. 1 is an illustrative example of a schematic diagram of a cascaded serial connection of device driver circuits. As shown in the example of FIG. 1, a system 100 includes a plurality of device driver circuits 104s (104_1, 104_2, …, 104_N) serially connected with each other and forming a daisy chain connection with a controller 102. Each of the plurality of device driver circuits 104s is configurable to drive one or more devices of a specific type. For a non-limiting example, each of the plurality of device driver circuits 104s can be but is not limited to a LCD/LED driver circuit and the type of the one or more devices can be but is not limited to LCD/LED. In one example, each of the plurality of device driver circuits 104s has a two-wire cascaded serial interface (CSI) for receiving data and clock into the device driver circuit 104 and transmitting data and clock out of the device driver circuit 104. Specifically, each of the plurality of device driver circuits 104s includes a data input pin/terminal 106 configurable to receive a data input signal used to control the one or more devices. Each of the plurality of device driver circuits 104s also includes a clock input pin/terminal 108 configurable to receive a clock input signal used to control operations of the device driver circuit 104. In one example, each of the plurality of device driver circuits 104s includes a data output pin/terminal 110 configurable to transmit a data output signal out of the device driver circuit 104 as well as a clock output pin/terminal 112 configurable to transmit a clock output signal out of the device driver circuit 104.

In one example, the controller 102 can be but is not limited to a micro controller unit (MCU) or any other type of controller configurable to control the plurality of device driver circuits 104s with data and clock outputs as discussed below. In one example, the plurality of device driver circuits 104s are configurable to communicate with each other and the controller 102 for data and clock input/output signals following the SPI communication protocol.

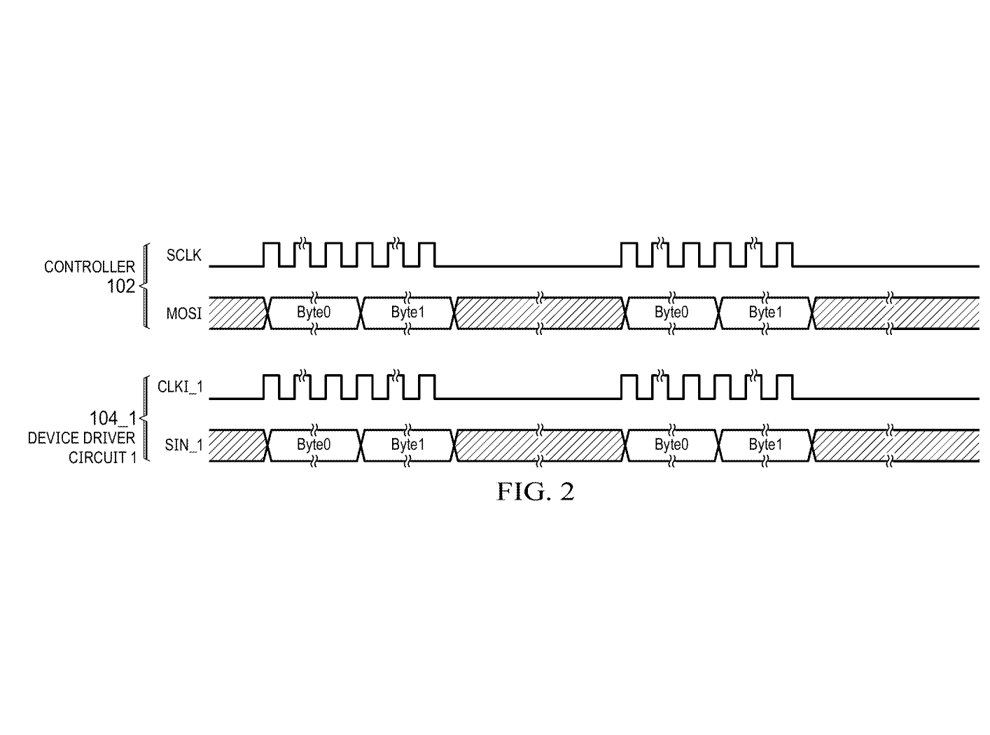

In one example, a first device driver circuit 104_1 in the plurality of device driver circuits 104s is configurable to receive from the controller 102 a system clock output signal SCLK at its clock input pin 108_1 as its clock input signal CLKI_1 as shown in FIG. 1. The first device driver circuit 104_1 is also configurable to receive a data output signal, e.g., Master Out Slave In (MOSI), from the controller 102, as its data input signal SIN_1, wherein the data input signal SIN_1 is used to drive the first device driver circuit 104_1. FIG. 2 depicts an example of waveforms of the system clock output signal SCLK and the data output signal MOSI transmitted from the controller 102 as well as the corresponding clock input signal CLKI and data input signal SIN_1 received at the first device driver circuit 104_1. In one example, the first device driver circuit 104_1 is configurable to transmit its clock output signal CLKO_1 at its clock output pin 112_1 as the clock input signal CLKI_2 to a next device driver circuit 104_2 serially/subsequently connected to the first device driver circuit 104_1 in the plurality of device driver circuits 104s. The first device driver circuit 104_1 is also configurable to transmit its data output signal SOUT_1 at its data output pin 110_1 as the data input signal SIN_2 to the next device driver circuit 104_2 serially connected to the first device driver circuit 104_1.

In one example, a last device driver circuit 104_N in the plurality of device driver circuits 104s is configurable to receive, from a previous device driver circuit serially connected to the last device driver circuit 104_N in the plurality of device driver circuits 104s, a data output signal as its data input signal at its data input pin 110_N. The last device driver circuit 104_N is also configurable to receive, from its previous device driver circuit, a clock output signal as its clock input signal at its clock input pin 108_N. In one example, the last device driver circuit 104_N is configurable to transmit its clock output signal CLKO_N at its clock output pin 112_N and its data output signal SOUT_N at its data output pin 110_N to the respective input pins/terminals of the controller 102 as shown in FIG. 1.

In the example where the plurality of device driver circuits 104s have more than two (e.g., the first and the last) device driver circuits, each remaining device driver circuit in the plurality of device driver circuits, e.g., 104_2, is configurable to receive, from a previous device driver circuit, e.g., 104_1, serially connected to the remaining device driver circuit 104_2, a clock output signal, e.g., CLKO_1, as its clock input signal CLKI_2 at its clock input pin 108_2. Each remaining device driver circuit 104_2 is also configurable to receive from the previous device driver circuit 104_1 a data output signal SOUT_1 as its data input signal SIN_2 at its data input pin 106_2. In one example; each remaining device driver circuit 104_2 is configurable to transmit, to a next device driver circuit (not shown) serially/subsequently connected to the each remaining device driver circuit 104_2 in the plurality of device driver circuits, its clock output signal CLKO_2 at its clock output pin 112_2 and its data output signal as the clock input signal and the data input signal to the next device driver circuit, respectively.

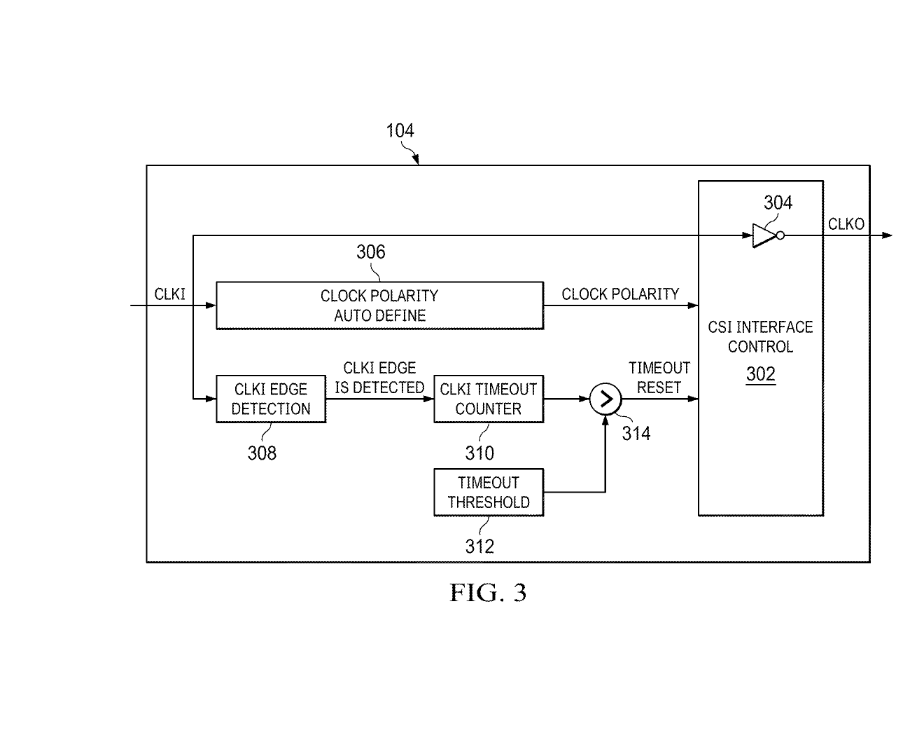

FIG. 3 depicts an example of a schematic diagram of circuitries inside each device driver circuit 104, wherein such circuitries are used to process the clock input signal CLKI received into the device driver circuit 104. As shown by the example of FIG. 3, the device driver circuit 104 includes a CSI control unit 302 configurable to control operations of the device driver circuit 104 based on the clock input signal CLKI. In one example, the CSI control unit 302 includes an inverter 304 configurable to take the clock input signal CLKI as its input, and to generate the clock output signal CLKO of the device driver circuit 104 by inverting/reversing the clock input signal CLKI. As a result, the clock output signal CLKO from each of the plurality of device driver circuits 104s is an inverse of its clock output signal CLKI. Because the clock output signal CLKO from each device driver circuit 104 is transmitted to and received/accepted by the next serially connected device driver circuit 104 as discussed above, the clock input signals between two adjacent device driver circuits 104s are the inverse of each other, e.g., when one of the clock input signals goes high with a positive/rising edge, the other one goes low with a negative/falling edge. Such clock input signal inversion eliminates the timing affects caused by distorted/corrupted CLKI duty cycles as the number of cascaded device driver circuits increases.

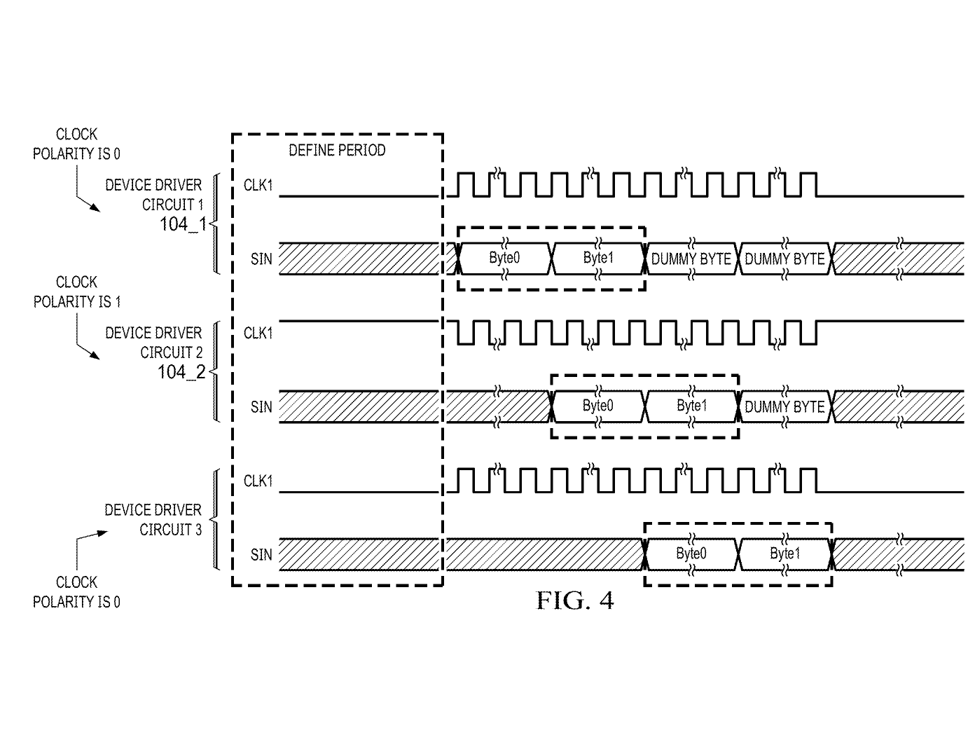

In one example, one or more of the plurality of device driver circuits 104s include a clock polarity defining unit 306 configurable to recognize an initial voltage level of its clock input signal CLKI after the device driver circuit 104 is powered up. The clock polarity defining unit 306 then automatically and adaptively defines a clock (mode) polarity of the device driver circuit 104 based on the initial voltage level of its clock input signal CLKI. FIG. 4 depicts an example of levels of clock input signals CLKIs and data input signals SINs at the first device driver circuit 104_1, the second device driver circuit 104_2, and a third device driver circuit (not shown in FIG. 1) following the second device driver circuit 104_2 in the plurality of device driver circuits 104s. As shown in the example of FIG. 4, if the initial voltage level of the clock input signal CLKI is low during a define period immediately after a device driver circuit 104 (e.g., the first device driver circuit 104_1) is powered up, its clock polarity is automatically defined as 0. Since the clock input signals between two adjacent device driver circuits 104s are the inverse of each other as discussed above, the initial voltage level of the clock input signal CLKI to the second device driver circuit 104_2 is high and its clock polarity is automatically defined as 1. In other words, the clock polarity of each device driver circuit 104 is an inverse/opposite (e.g., 0 vs. 1) of the clock polarity of its previous and/or the next serially connected device driver circuits in the plurality of device driver circuits 104s. If the initial voltage level of the clock input signal CLKI of a device driver circuit (e.g., 104_1) is low and its clock polarity is 0, the device driver circuit 104_1 is configurable to receive its data input signal SIN as triggered by a positive/rising edge of its input clock signal CLKI as shown by FIG. 4. If, on the other hand, the initial voltage level of the clock input signal CLKI of a device driver circuit (e.g., 104_2) is high and its clock polarity is 1, the device driver circuit 104_2 is configurable to receive its data input signal SIN as triggered by a negative/falling edge of its input clock signal CLKI.

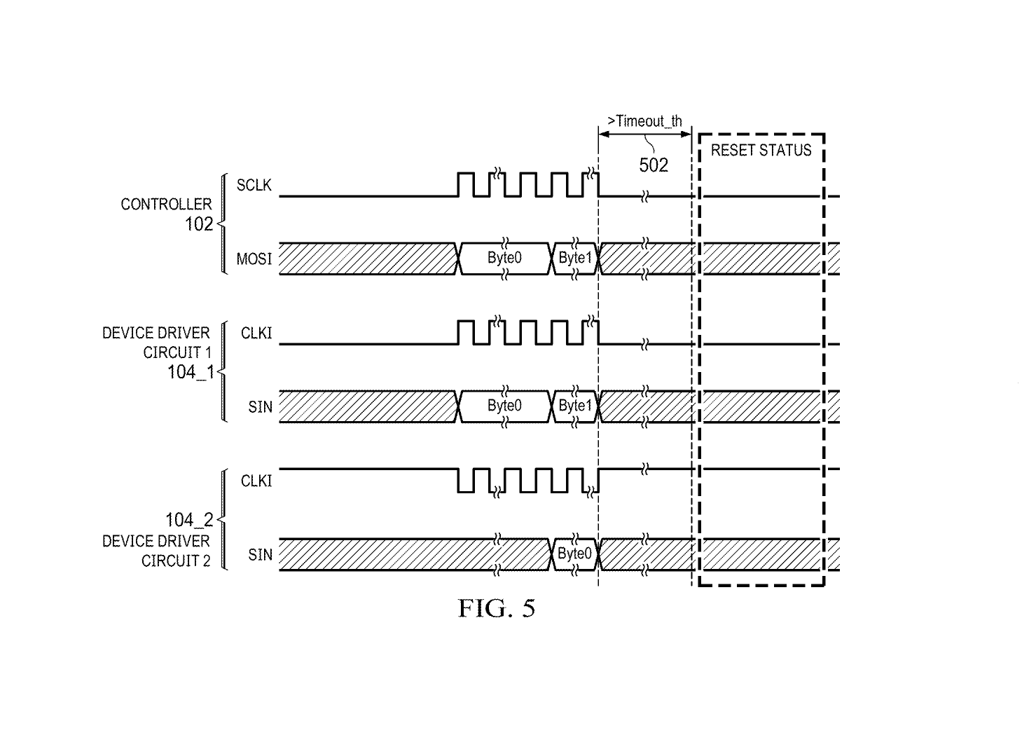

In one example, one of the plurality of device driver circuits 104s includes an input clock edge detection unit 308 (as shown in FIG. 3) configurable to monitor toggling of the input clock signal CLKI to the device driver circuit 104 by detecting a positive/rising edge (if its clock polarity is 0) or a negative/falling edge (if its clock polarity is 1) of the input clock signal CLKI. In one example, an input clock signal timeout counter 310 is configurable to keep track of a timeout period for the input clock signal when the input clock signal is not toggling, i.e., no clock edge is detected by the input clock edge detection unit 308. The timeout period is then compared with a preset timeout threshold stored in a register or a memory 312 via a comparator 314. If the timeout period exceeds the preset timeout threshold, the comparator sends a timeout reset signal to the CSI control unit 302, which then resets/auto recovers the two-wire cascaded serial interface (CSI) of the device driver circuit 104 to stop receiving input data signal SIN. If an input clock edge is detected by the input clock edge detection unit 308, the input clock edge detection unit 308 transmits a signal to the input clock signal timeout counter 310 so the input clock signal timeout counter 310 will reset the timeout period of the input clock signal. FIG. 5 depicts an example of waveforms of the clock output signal SCLK and data output signal MOSI from the controller 102 as well as clock input signals CLKIs and data input signals SINs at the first device driver circuit 104_1 and the second device driver circuit 104_2 during a timeout. If the clock output signal SCLK and the clock input signals CLKIs stop toggling for a timeout period 502 that exceeds the preset timeout threshold, the CSIs of the first device driver circuit 104_1 and the second device driver circuit 104_2 are reset and no data input from the controller 102 is accepted or processed.

In this description, the term “coupled” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within +/- 10 percent of that parameter or, if the parameter is zero, a reasonable range of values around zero.

Modifications are possible in the described embodiments, and other embodiments are possible, within the scope of the claims.

What is claimed is:

1. An apparatus comprising:
a plurality of device driver circuits, each configurable to drive one or more devices of a specific type, wherein the plurality of device driver circuits are serially connected in a chain connection, and wherein
each of the plurality of device driver circuits includes
a data input pin configurable to receive a data input signal;
a clock input pin configurable to receive a clock input signal;
a data output pin configurable to transmit a data output signal;
a clock output pin configurable to transmit a clock output signal; and
an inverter configurable to generate the clock output signal by inverting the clock input signal.

2. The apparatus of claim 1, wherein:
each of the plurality of device driver circuits is a LED driver circuit and the one or more devices are LEDs.

3. The apparatus of claim 1, wherein:
a first device driver circuit in the plurality of device driver circuits is configurable to
receive, from a controller, a clock signal as its clock input signal and a data signal as its data input signal; and
transmit, to a next device driver circuit serially connected to the first device driver circuit in the plurality of device driver circuits, its clock output signal and its data output signal as the clock input signal and the data input signal to the next device driver circuit, respectively, and wherein
a last device driver circuit in the plurality of device driver circuits is configurable to
receive, from a previous device driver circuit serially connected to the last device driver circuit in the plurality of device driver circuits, a clock output signal as its clock input signal and a data output signal as its data input signal; and
transmit, to the controller, its clock output signal and its data output signal.

4. The apparatus of claim 3, wherein:
each remaining device driver circuit in the plurality of device driver circuits is configurable to
receive, from a previous device driver circuit serially connected to the each remaining device driver circuit in the plurality of device driver circuits, a clock output signal as its clock input signal and a data output signal as its data input signal; and
transmit, to a next device driver circuit serially connected to the each remaining device driver circuit in the plurality of device driver circuits, its clock output signal and its data output signal as the clock input signal and the data input signal to the next device driver circuit, respectively.

5. The apparatus of claim 3, wherein:
the controller is a micro controller unit (MCU).

6. The apparatus of claim 3, wherein:
the plurality of device driver circuits are configurable to communicate with each other and the controller via Serial Peripheral Interface (SPI) protocol.

7. The apparatus of claim 1, wherein:
each of the plurality of device driver circuits is configurable to
recognize an initial voltage level of its clock input signal after the each of the plurality of device driver circuits is powered up; and
automatically define a clock polarity of the each of the plurality of device driver circuits.

8. The apparatus of claim 7, wherein:
the clock polarity of each of the plurality of device driver circuits is an inverse of the clock polarity of its previous and/or the next serially connected device driver circuits in the plurality of device driver circuits.

9. The apparatus of claim 7, wherein:
each of the plurality of device driver circuits is configurable to receive its data input signal as triggered by a negative edge of its input clock signal when the initial voltage level of its clock input signal is high.

10. The apparatus of claim 7, wherein:
each of the plurality of device driver circuits is configurable to receive its data input signal as triggered by a positive edge of its input clock signal when the initial voltage level of its clock input signal is low.

11. An apparatus comprising:
a plurality of device driver circuits, each configurable to drive one or more devices of a specific type, wherein the plurality of device driver circuits are serially connected in a chain connection, and wherein
each of the plurality of device driver circuits includes
a data input pin configurable to receive a data input signal;
a clock input pin configurable to receive a clock input signal;
a data output pin configurable to transmit a data output signal;
a clock output pin configurable to transmit a clock output signal; and
a circuitry configurable to
determine a timeout period of the input clock signal; and
reset the each of the plurality of device driver circuits if the timeout period of its input clock signal exceeds a preset timeout threshold.

12. The apparatus of claim 11, wherein:
the circuitry is configurable to determine the timeout period of the input clock by monitoring toggling of its input clock signal.

13. The apparatus of claim 11, wherein:
the circuitry is configurable to maintain the timeout threshold in a register.

14. A method, comprising:
receiving a data input signal at each of a plurality of device driver circuits each configurable to drive one or more devices of a specific type, wherein the plurality of device driver circuits are serially connected in a chain connection;
receiving a clock input signal at the each of a plurality of device driver circuits;
transmitting a data output signal at the each of a plurality of device driver circuits; and
transmitting a clock output signal at the each of a plurality of device driver circuits, wherein the clock output signal is inverted from the clock input signal.

15. The method of claim 14, further comprising:
receiving, from a controller, a clock signal as its clock input signal and a data signal as its data input signal at a first device driver circuit in the plurality of device driver circuits;
transmitting, to a next device driver circuit serially connected to the first device driver circuit in the plurality of device driver circuits, its clock output signal and its data output signal as the clock input signal and the data input signal to the next device driver circuit, respectively;
receiving, from a previous device driver circuit serially connected to the last device driver circuit in the plurality of drivers, a clock output signal as its clock input signal and a data output signal as its data input signal at a last device driver circuit in the plurality of device driver circuits; and
transmit, to the controller, its clock output signal and its data output signal.

16. The method of claim 15, further comprising:
receiving, from a previous device driver circuit serially connected to the each remaining device driver circuit in the plurality of device driver circuits, a clock output signal as its clock input signal and a data output signal as its data input signal at each remaining device driver circuit in the plurality of device driver circuits; and
transmit, to a next device driver circuit serially connected to the each remaining device driver circuit in the plurality of device driver circuits, its clock output signal and its data output as the clock input signal and the data input signal to the next device driver circuit, respectively.

17. The method of claim 16, further comprising:
receiving, from a previous device driver circuit serially connected to the each remaining device driver circuit in the plurality of device driver circuits, a clock output signal as its clock input signal and a data output signal as its data input signal at each remaining device driver circuit in the plurality of device driver circuits; and
transmitting, to a next device driver circuit serially connected to the each remaining device driver circuit in the plurality of device driver circuits, its clock output signal and its data output as the clock input signal and the data input signal to the next device driver circuit, respectively.

18. The method of claim 16, further comprising:
communicating with the controller and among the plurality of device driver circuits via Serial Peripheral Interface (SPI) protocol.

19. The method of claim 14, further comprising:
recognizing an initial voltage level of its clock input signal at each of the plurality of device driver circuits after the each of the plurality of device driver circuits is powered up; and
automatically defining a clock polarity of the each of the plurality of device driver circuits.

20. The method of claim 19, wherein:
the clock polarity of each of the plurality of device driver circuits is an inverse of the clock polarity of its previous and/or the next serially connected device driver circuits in the plurality of device driver circuits.

21. The method of claim 19, further comprising:
receiving at each of the plurality of device driver circuits its data input signal as triggered by a negative edge of its input clock signal when the initial voltage level of its clock input signal is high.

22. The method of claim 19, further comprising:
receiving at each of the plurality of device driver circuits its data input signal as triggered by a positive edge of its input clock signal when the initial voltage level of its clock input signal is low.

23. A method, comprising:
receiving a data input signal at each of a plurality of device driver circuits each configurable to drive one or more devices of a specific type, wherein the plurality of device driver circuits are serially connected in a chain connection;
receiving a clock input signal at the each of a plurality of device driver circuits;
transmitting a data output signal at the each of a plurality of device driver circuits;
transmitting a clock output signal at the each of a plurality of device driver circuits;
determining a timeout period of the input clock signal; and
resetting the each of the plurality of device driver circuits if the timeout period of its input clock signal exceeds a preset timeout threshold.

24. The method of claim 23, further comprising:
determining the timeout period of the input clock by monitoring toggling of its input clock signal.

25. The method of claim 23, further comprising:
maintaining the timeout threshold in a register.
